(19) United States
(12) Patent Application Publication
(10) Pub. No.: US 2014/0353986 A1
(43) Pub. Date: Dec. 4, 2014

(54) ELECTRONIC LOCKING SYSTEM FOR A VEHICLE DOOR AND A METHOD FOR OPERATING AN ELECTRONIC LOCKING SYSTEM FOR A VEHICLE DOOR

(71) Applicant: GM GLOBAL TECHNOLOGY OPERATIONS LLC, Detroit, MI (US)

(72) Inventors: Matthias Notheis, Nieder-Hilbersheim (DE); Andreas Heberer, Mainz (DE)

(73) Assignee: GM GLOBAL TECHNOLOGY OPERATIONS LLC, Detroit, MI (US)

(21) Appl. No.: 14/293,049

(22) Filed: Jun. 2, 2014

(30) Foreign Application Priority Data
May 31, 2013 (DE) 102013009242.6

(51) Int. Cl. E05B 47/00

(52) U.S. Cl. CPC E05B 47/0012
USPC 292/336.3

(57) ABSTRACT

An electronic locking system for a vehicle door is disclosed. The locking system includes an actuating device for actuating the locking system by a user. The actuating device brings about a movement of an actuating element of the actuating device. The locking system also includes a generator for generating electric energy from the movement energy of the actuating element, and an electric motor for actuating the locking system.

### CROSS REFERENCE TO RELATED APPLICATION

This application claims priority to German Patent Application No. 102013009242.6 filed May 31, 2013, which is incorporated herein by reference in its entirety.

### TECHNICAL FIELD

The technical field relates to an electronic system for a vehicle door. It relates furthermore to a method for operating an electronic locking system for a vehicle door.

### BACKGROUND

For vehicle doors, mechanically operating locking systems are known on the one hand, with which actuating a door handle results in the door being opened via a control cable, when the door is unlatched. Compared with this, electronic locking systems have the advantage of substantial weight saving. However, using an electronic locking system poses the object of keeping electric energy for opening the vehicle door available in the event of a failure of the vehicle electrical system. From DE 10 2007 012 505 A1 possibilities of capacitive energy storage in a vehicle are known.

### SUMMARY

In accordance with the present a technically simple and robust electronic locking system for a vehicle door is provided, with which opening the doors is reliably possible even upon a failure of the vehicle's electrical system. Furthermore, a method for operating such an electronic locking system is to be stated.

According to an aspect of the present disclosure, an electronic locking system for a vehicle door includes at least one actuating device for actuating the locking system by a user. Actuation of the actuating device brings about a movement of an actuating element of the actuating device. The actuating device includes an actuating element, which is moved when actuated by a user. The electronic locking system furthermore includes at least one generator for generating electric energy from the movement energy of the actuating element and an electric motor for actuating the locking system.

The actuating device can in particular be a door handle on the vehicle door. The actuating element can then either be the door handle such that the actuating element and the actuating device are one and the same, or the actuating element may be a part of the locking system, which likewise moves upon the movement of the door handle and the movement energy of which can be supplied to the generator in a particularly simple manner.

The locking system has the advantage that compared with known mechanical systems it has a low weight, more so since it omits mechanical redundancies. In addition, it renders the storage of electric energy for emergency power operation superfluous. As fully electronic locking system it has the advantage, furthermore, that the generated signals are relatively secure, i.e. are difficult to manipulate.

In an embodiment, the electric motor can be operated with electric energy generated by the generator. This has the advantage that actuating, in particular opening the vehicle door is possible alone with energy provided by the generator and thus can be carried out even upon a failure of the vehicle's electrical system. Storing of electric energy is thus not required.

In an embodiment, the electric motor can be additionally operated with electric energy made available by a vehicle's electrical system. This has the advantage that as a rule operation can take place via the vehicle's electrical system, which is more efficient than the operation via the energy provided by the generator. Merely upon a failure of the vehicle's electrical system will the supply by the generator be utilized. The supply of the generator thus constitutes a possibility of the emergency power supply.

In an embodiment, the electric motor can be activated by a control unit. The control unit, also described as control device, has the object in particular of deciding if opening of the door is permitted. When the vehicle door is latched, actuating of the actuating device brings about opening of the door for example only when in particular a crash of the vehicle or another emergency situation has been additionally detected. To this end, the control unit evaluates relative signals and suitably activates the electric motor when opening of the door is permitted. The control unit can in particular include a microprocessor. It can be likewise supplied with the electric energy generated by the generator.

In an embodiment, the generator includes a transmission gearing. For example, a transmission ratio of 1:1,000 can be appropriate. In some cases, transmission can also be omitted.

In an embodiment, the actuating device is designed as a door handle. The actuating element can likewise be the door handle or another element of the locking system, which is mechanically connected to the door handle and is moved when said door handle is actuated.

According to an aspect of the present disclosure, a vehicle with the described electronic locking system is stated. It has the advantage that secure opening and locking of the vehicle door is possible at any time, even in the case of a crash and/or upon a failure of the vehicle's electrical system. As a fully electronic system it additionally has the advantage of low weight.

According to a further aspect of the present disclosure, a method for operating an electronic locking system for a vehicle door is stated, wherein the method includes the conversion of movement energy of an actuating device actuated by a user into electric energy, and the operating of an electric motor with electric energy for unlatching the locking system. The method includes the possibility of operating the electric motor with electric energy, which was generated by converting movement energy. The user himself supplies the necessary movement energy through actuating the actuating device, and which accordingly is available exactly at the time at which it is needed, without technically elaborate storage being required for this purpose.

In an embodiment, a check is carried out prior to activating the electric motor as to whether unlatching of the locking system is permitted. Accordingly it is checked if the actuation of the actuating device by the user is to bring about unlatching. Unlatching of the locking system is not permitted when the vehicle door is electronically latched. Electronic latching in this case can be brought about both through conventional locking of the vehicle door as well as through an activated child lock.

Unlatching of the locking system at any rate can always be permitted in particular when an emergency situation was detected. Such can be determined in particular through a positive signal of a crash sensor. It can be determined in particular that unlatching through operating the electric motor with electric energy generated from movement energy is not carried out when the check shows that electric energy from a vehicle's electrical system is available. Because of this it is ensured that the most energy-efficient way for operating the electric motor is always selected. Because of the losses in the conversion of mechanical into electric energy the user of energy from the vehicle's electrical system constitutes the more efficient solution in most cases and is therefore preferred in this embodiment when the vehicle's electrical system is available.

A further aspect of the present disclosure relates to a computer program product which, when it is executed on a control unit of a motor vehicle, instructs the control unit to carry out the described method. The control unit is instructed in particular for operating an electric motor with electric energy for unlatching the locking system, wherein the electric energy is selected from a group consisting of energy through the conversion of movement energy of an actuating device actuated by a user into electric energy and energy made available through the vehicle's electrical system.

A further aspect of the present disclosure, furthermore, relates to a computer-readable medium, on which a computer program product according to the mentioned embodiments is stored. The computer program product and the computer-readable medium according to the mentioned embodiments include the advantages already mentioned in connection with the corresponding method, which are not mentioned again at this point to avoid repetitions.

### BRIEF DESCRIPTION OF THE DRAWINGS

The present disclosure will hereinafter be described in conjunction with the following drawing figures, wherein like numerals denote like elements, and:

FIG. 1 schematically shows an electronic locking system for a vehicle door according to an embodiment of the present disclosure and

FIG. 2 schematically shows steps of a method for operating an electronic locking system according to an embodiment of the present disclosure and components of the electronic locking system.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

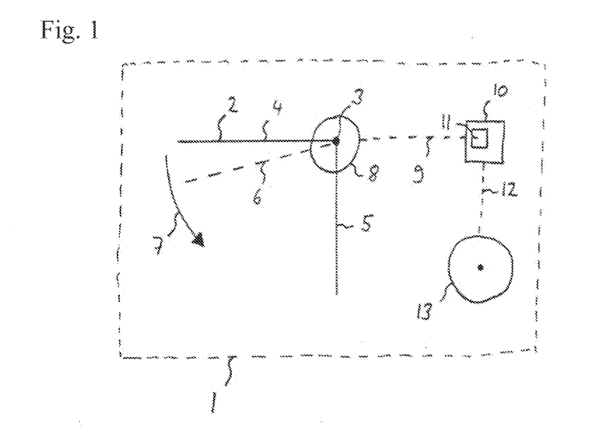

FIG. 1 shows an electronic locking system 1 for a vehicle door, for example a vehicle door of a passenger motorcar. The locking system 1 includes an actuating device with an actuating element designed as a door handle 2.

When actuated by a user in order to open the vehicle door, the door handle 2 rotates about an axis of rotation 3. It can be moved between an unactuated basic position 4 and a completely actuated position 5. This movement is indicated in FIG. 1 by the intermediate position 6 and the arrow 7. When actuating the door handle 2, the user ideally introduces so much energy into the system as corresponds to a rotation of the door handle 2 from its basic position 4 into its completely actuated position 5.

The axis of rotation 3 corresponds to the axis of rotation of a generator 8, which converts the movement energy of the door handle 2 into electric energy. The generator 8 is connected through a line 9 with a control unit 10, which includes a microprocessor 11. The control unit 10 can furthermore include a storage device, which is not shown in the figures for storing the electric energy generated or provided by the generator. For such a storage device, storage capacitors can be used for example. The control device 10 is preferably connected to an electrical system of the passenger car via a line, which is not shown in more detail. The control unit 10 furthermore is connected to an electric motor 13 via a signal line 12. The electric motor 13 serves for unlatching the vehicle door and can be supplied if appropriate with energy generated by the generator 8.

When the door handle 2 is actuated, the control unit 10 with the microprocessor 11 is awakened and supplied with electric energy if appropriate. Following this the microprocessor 11 checks if opening the vehicle door is to take place or is permitted. When the vehicle door is not latched—either through a usual locking operation or through an activated child lock—it is checked, furthermore, if electric energy from the vehicle's electrical system is available. If this is not the case, the electric motor 13 is supplied with electric energy generated with the generator 8 and activated in order to open the vehicle door.

In the case that the vehicle door is latched, it is checked, furthermore, if other criteria—for example a positive signal of a crash sensor—speak in favor of opening the door. If this is not the case, the vehicle door remains locked. If the door is to be opened, however it is also checked in this case if electric energy from a vehicle's electrical system is available. If this is not the case, the electric motor 13 is supplied with electric energy generated with the generator 8 and activated in order to open the vehicle door.

If the vehicle door is to be opened, but electric energy from the vehicle's electrical system is available, the electric motor 13 is operated with the latter and the vehicle door opened. The supply via the generator 8 thus constitutes an emergency power operation for the locking system 1.

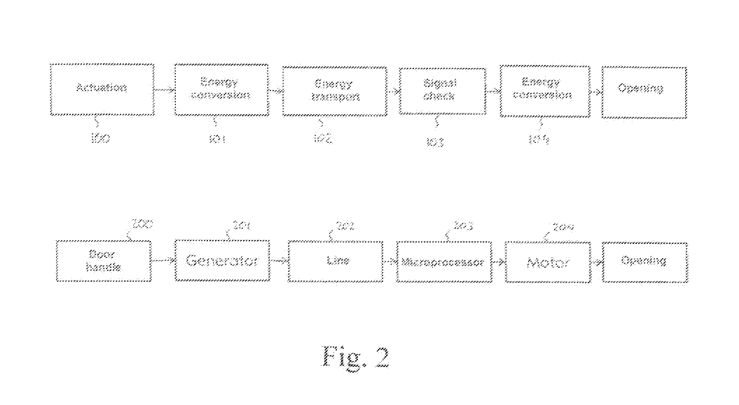

In the upper half of FIG. 2 the step 100 to 104 of a method for operating the locking system 1 are shown. In the lower half of the FIG. 2, the components 200 to 204 used in each case for carrying out the steps 100 to 104 are shown.

In a first step 100, actuating the door handle 2 as a first component 200 by a user takes place. In a second step 100, the movement energy of the door handle 2 is converted into electric energy by the second component 201, the generator 8. In a third step 102, the generated electric energy is transported to the control unit 10 via the third component 202, electric lines. In a fourth step 103, a signal check takes place during which it is checked if the vehicle door is to be opened. As fourth component 203, the microprocessor 11 of the control unit 10 carries out this check. In a fifth step 104, an energy conversion is carried out again, namely by the electric motor 13 as fifth component 204, which brings about opening of the vehicle door.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-13. (canceled)

14. An electronic locking system for a vehicle door comprising:
an actuating device for actuating the locking system by a user, wherein actuating the actuating device moves an actuating element of the actuating device;
an electric motor configured to be operably coupled to a door locking system; and
a generator mechanically coupled to the actuating element for generating electric energy from movement thereof and electrically coupled to the electric motor for selectively supply electrical energy thereto.

15. The electronic locking system according to claim 14, wherein the electric motor is operated with electric energy generated by the generator.

16. The electronic locking system according to claim 14, wherein the electric motor is operated with electric energy made available by an electrical system of the vehicle.

17. The electronic locking system according to claim 14, further comprising a control unit operable to activate the electric motor.

18. The electronic locking system according to claim 17, wherein the control unit comprises a microprocessor.

19. The electronic locking system according to claim 14, further comprising a transmission gearing coupling the actuating element and the generator.

20. The electronic locking system according to claim 14, wherein the actuating device comprises a door handle.

21. A vehicle with an electronic locking system comprising:
a vehicle door including a locking system;
an actuating device for actuating the locking system by a user, wherein actuating the actuating device moves an actuating element of the actuating device;
an electric motor operably coupled to the door locking system; and
a generator mechanically coupled to the actuating element for generating electric energy from movement thereof and electrically coupled to the electric motor for selectively supply electrical energy thereto.

22. A method for operating an electronic locking system for a vehicle door comprising:
converting movement energy of an actuating device actuated by a user into electric energy;
operating an electric motor with the electric energy for unlatching a locking system for a vehicle door.

23. The method according to claim 22, wherein checking whether unlatching of the locking system is permitted prior to operating the electric motor.

24. The method according to claim 23, wherein unlatching of the locking system is permitted when an emergency situation was determined.

25. The method according to claim 23, wherein unlatching of the locking system is not permitted when the vehicle door is electronically latched.

26. The method according to claim 25, wherein unlatching of the locking system is permitted when an emergency situation was determined.

27. The method according to any one of the claims 22, wherein unlatching through operating the electric motor with electric energy generated through the conversion of movement energy is disabled when the check shows that electric energy from a vehicle's electrical system is available.
